(19) United States
(12) Patent Application Publication
(10) Pub. No.: US 2016/0298528 A1
(43) Pub. Date: Oct. 13, 2016

(54) Ducted Combustion Systems Utilizing Curved Ducts

(71) Applicant: Caterpillar Inc., Peoria, IL (US)

(72) Inventor: Kenth Svensson, Peoria, IL (US)

(73) Assignee: CATERPILLAR INC., Peoria, IL (US)

(21) Appl. No.: 14/685,140

(22) Filed: Apr. 13, 2015

(51) Int. Cl. F02B 3/00; F02F 3/28; F02B 23/06

(52) U.S. Cl. CPC F02B 3/00; F02B 23/0618; F02B 23/0645; F02B 23/0669; F02F 3/28

(57) ABSTRACT

A ducted combustion system is disclosed. The ducted combustion system includes a combustion chamber bound by a flame deck surface of a cylinder head of an internal combustion engine and by a piston top surface of a piston disposed within the internal combustion engine. The system includes a fuel injector including a plurality of orifices, the plurality of openings injecting fuel into the combustion chamber as a plurality of fuel jets. The system includes a duct structure defining a plurality of curved ducts and disposed within the combustion chamber between the flame deck surface and the piston top surface, the plurality of ducts being disposed such that each of the plurality of fuel jets, at least partially, enters one of the plurality of ducts upon being injected into the combustion chamber.

### TECHNICAL FIELD

The present disclosure generally relates to internal combustion engines and, more particularly, relates to ducted combustion systems for internal combustion engines.

### BACKGROUND

Modern combustion engines may include one or more cylinders as part of the engine. The cylinder and an associated piston may define a combustion chamber therebetween. Within the combustion chamber, fuel for combustion is directly injected into the combustion chamber by, for example, a fuel injector, which is associated with the cylinder and has an orifice disposed such that it can directly inject fuel into the combustion chamber.

Different mixtures and/or equivalence ratios of the fuel/air mixture within the fuel jet may produce different results during combustion. The manners in which the injected fuel mixes and/or interacts with the air and other environmental elements of the combustion chamber may impact combustion processes and associated emissions. Further, if the fuel and air mixing is inadequate, then suboptimal or abnormally large amounts of soot may form within the combustion chamber.

To aid in preventing or reducing soot formation and to increase efficiency in such combustion engines, systems and methods for ducted combustion have been developed. For example, U.S. Patent Publication No. 2012/0186555 (“Ducted Combustion Chamber for Direct Injection Engines and Method”) discloses ducted combustion within a combustion engine. The ducts of the '555 application generally include fins disposed around a fuel jet injected by a fuel injector. Such ducts may form a passageway corresponding to an orifice of the fuel injector, into which fuel jets are injected. The fuel jets may be channeled into the ducts, which may improve fuel combustion because upstream regions of a direct-injected fuel jet may be affected by faster and more uniform mixing as well as by an inhibition or reduction of entrainment of combustion products from downstream regions of the same or neighboring jets.

While the teachings of the '555 application are advantageous in providing an improved fuel/air mixture, further improvements in fuel/air mixtures are always desired, as such improvements may further reduce emissions and soot formation. Therefore, systems and methods for ducted combustion that utilize duct structures, defining a plurality of curved ducts, for improving fuel/air mixtures are desired.

### SUMMARY

In accordance with one aspect of the disclosure, a ducted combustion system is disclosed. The ducted combustion system may include a combustion chamber, which is defined as an enclosure bound at a first end by a flame deck surface of a cylinder head of an internal combustion engine and bound at a second end by a piston top surface of a piston disposed within the internal combustion engine. The system may further include a fuel injector in fluid connection with the combustion chamber and including a plurality of orifices in an injector tip of the fuel injector, the plurality of orifices injecting fuel into the combustion chamber as one or more fuel jets. The system may further include a duct structure defining a plurality of curved ducts and disposed within the combustion chamber between the flame deck surface and the piston top surface, the plurality of ducts being disposed such that each of the plurality of orifices inject each of the plurality of fuel jets, at least partially, into one of the plurality of curved ducts.

In accordance with another aspect of the disclosure, an internal combustion engine is disclosed. The internal combustion engine may include an engine block having at least one cylinder bore. The internal combustion engine may further include a cylinder head having a flame deck surface disposed at one end of the cylinder bore. The internal combustion engine may further include a piston connected to a crankshaft and configured to reciprocate within the cylinder bore, the piston having a piston top surface facing the flame deck surface such that a combustion chamber is defined within the cylinder bore bound at a first end by the flame deck surface and at a second end by the piston top surface. The internal combustion engine may further include a fuel injector in fluid connection with the combustion chamber and including a plurality of orifices in an injector tip of the fuel injector, the plurality of orifices injecting fuel into the combustion chamber as one or more fuel jets. The internal combustion engine may further include a duct structure defining a plurality of curved ducts and disposed within the combustion chamber between the flame deck surface and the piston top surface, the plurality of ducts being disposed such that each of the plurality of orifices inject each of the plurality of fuel jets, at least partially, into one of the plurality of curved ducts.

In accordance with yet another aspect of the disclosure, a method for operating a combustion system is disclosed. The method may include injecting a plurality of fuel jets into a combustion chamber of an internal combustion engine, the combustion chamber defined as an enclosure bound at a first end by a flame deck of a cylinder of an internal combustion engine, and bound at a second end by a piston top surface of a piston disposed within the internal combustion engine. The method may further include directing the plurality of fuel jets, at least partially, into respective members of a plurality of curved ducts, each of the plurality of curved ducts being defined within a duct structure, to provide a substantially uniform mixture of fuel and air within the combustion chamber.

Other features and advantages of the disclosed systems and principles will become apparent from reading the following detailed disclosure in conjunction with the included drawing figures.

### BRIEF DESCRIPTION OF THE DRAWINGS

FIG. 1 is a side cross-sectional view of an internal combustion engine, in accordance with an embodiment of the present disclosure.

FIG. 2 is a front, cross-sectional view of a cylinder of the internal combustion engine of FIG. 1, as shown taken from the reference notation “A” of FIG. 1, in accordance with the present disclosure.

FIG. 3 is a side view of a duct structure defining a plurality of curved ducts, disposed adjacent to openings on a fuel injector, for use within the cylinder(s) of FIGS. 1 and 2, in accordance with another embodiment of the disclosure.

FIG. 4 is a side view of a duct structure defining a plurality of curved ducts, disposed affixed to a piston of a cylinder, for use within the cylinder(s) of FIGS. 1 and 2, in accordance with another embodiment of the disclosure.

FIG. 5 is a side view of a duct structure defining a plurality of curved ducts, disposed affixed to a piston of a cylinder via a spring, for use within the cylinder(s) of FIGS. 1 and 2, in accordance with another embodiment of the disclosure.

FIG. 6 is a block diagram of a flowchart representative of a method for operating a combustion system, in accordance with an embodiment of the disclosure.

While the following detailed description will be given with respect to certain illustrative embodiments, it should be understood that the drawings are not necessarily to scale and the disclosed embodiments are sometimes illustrated diagrammatically and in partial views. In addition, in certain instances, details which are not necessary for an understanding of the disclosed subject matter or which render other details too difficult to perceive may have been omitted. It should therefore be understood that this disclosure is not limited to the particular embodiments disclosed and illustrated herein, but rather to a fair reading of the entire disclosure and claims, as well as any equivalents thereto.

### DETAILED DESCRIPTION

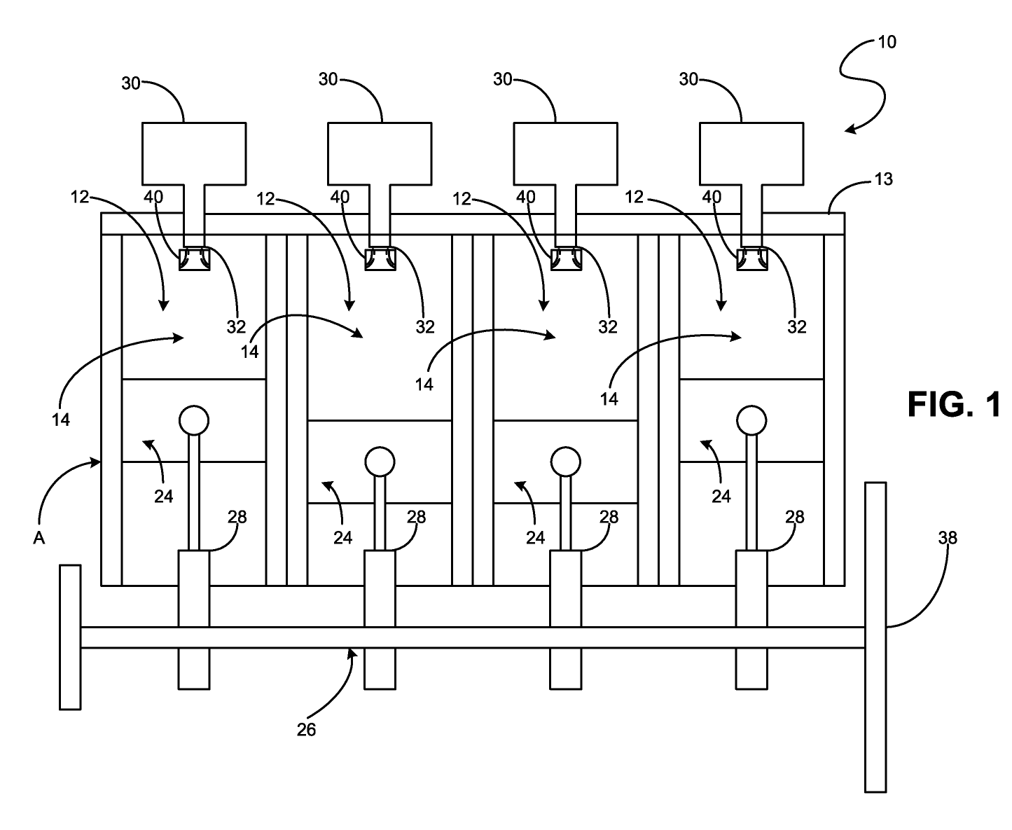

Turning now to the drawings and with specific reference to FIG. 1, a combustion engine 10 is shown. The engine 10 may be an internal combustion engine having a plurality of cylinders 12. For example, the cylinders 12 may be defined as cylinder bores within an engine block 13 of the engine 10. Each of the plurality of cylinders 12 includes a combustion chamber 14. Each combustion chamber 14 may have a generally cylindrical shape, in accordance with the general shape of the cylinder 12.

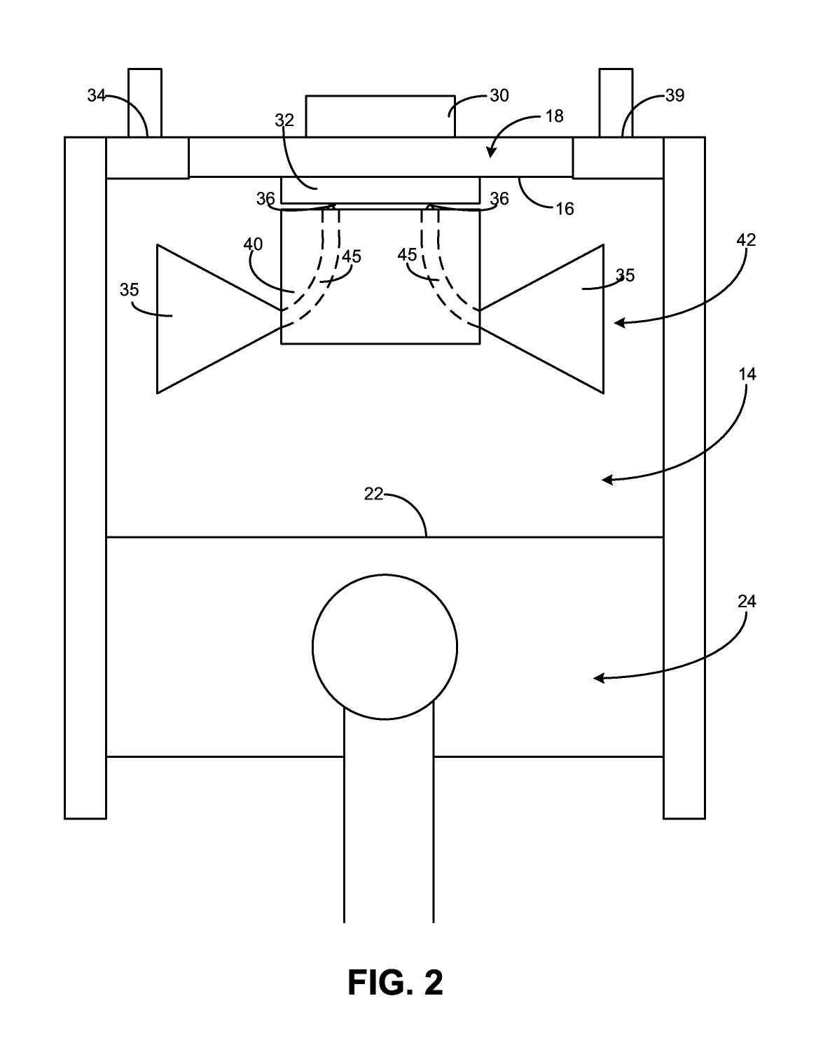

The combustion chamber 14 is shown in greater detail in the front, cross-sectional view of FIG. 2. As shown in FIG. 2, and with continued reference to FIG. 1, the combustion chamber 14 may be bound at one end by a flame deck surface 16 of a cylinder head 18 of each cylinder 12. The combustion chamber 14 may be further bound at a second end by a piston top surface 22 of a piston 24. The piston 24 is reciprocally disposed within the bore and, as shown in FIG. 1, is connected to a crankshaft 26 via a connecting rod 28. A fuel injector 30 is in fluid connection with the combustion chamber 14 and may be mounted in the cylinder head 18. The fuel injector 30 includes a tip 32 that protrudes within the combustion chamber 14 through the flame deck surface 16. Therefore, the fuel injector 30, via the tip 32, can directly inject fuel into the combustion chamber 14 as, for example, one or more fuel jets.

During operation of the engine 10, air enters the combustion chamber 14 via one or more intake valves 34 (shown in FIG. 2). Air is able to enter the combustion chamber 14 when the intake valves 34 are open during an intake stroke and/or at the end of an exhaust stroke and/or at the beginning of a compression stroke. When air is present in the combustion chamber 14, the fuel injector 30, via the tip 32, will inject high pressure fuel through orifices 36 of the tip 32 as fuel jets 35. The fuel jets 35 may generally disperse within the combustion chamber 14 to create a fuel/air mixture within the combustion chamber 14. Ignition produces combustion, which, in turn, provides work on the piston 24 to produce motion upon the crankshaft 26 to drive an output 38. Following combustion, exhaust gas may be expelled from the combustion chamber 14 via one or more exhaust valves 39, when said exhaust valves 39 are open during an exhaust stroke and/or at the end of a power stroke and/or at the beginning of an intake stroke of the engine 10.

Within the combustion chamber 14, uniformity of the fuel/air mixture may be relevant to the combustion efficiency and may be relevant to the amount and type of combustion byproducts that are formed. For example, if the fuel/air mixture is too rich in fuel due to insufficient mixing within the combustion chamber 14, then higher soot emissions may occur within the fuel jets 35 and/or combustion efficiency may be affected. However, using a duct structure 40, which defines a plurality of curved ducts 45, disposed within the combustion chamber 14 may provide for more uniform fuel/air mixing within the fuel jets 35. Using such a duct structure 40, which defines a plurality of ducts 45, a lift-off length of a flame associated with a fuel jet 35 may be altered (extended or reduced) to achieve an optimized lift-off length. The duct structure 40 may alter lift-off length due to energy exchange between the duct structure 40 and the fuel/air mixture of the fuel jet 35, due to altering fluid dynamics of the fuel/air mixture of the fuel jet 35, and/or due to prevention of lift-off length recession by acting as a flame arrester.

The duct structure 40 may be disposed within a flame region 42 of the combustion chamber 14. The flame region 42 may be defined as a region of the combustion chamber 14 extending from the flame deck surface 16 to the piston top surface 22, when the piston 24 is at or close to a maximum compression distance or top dead center (TDC) position.

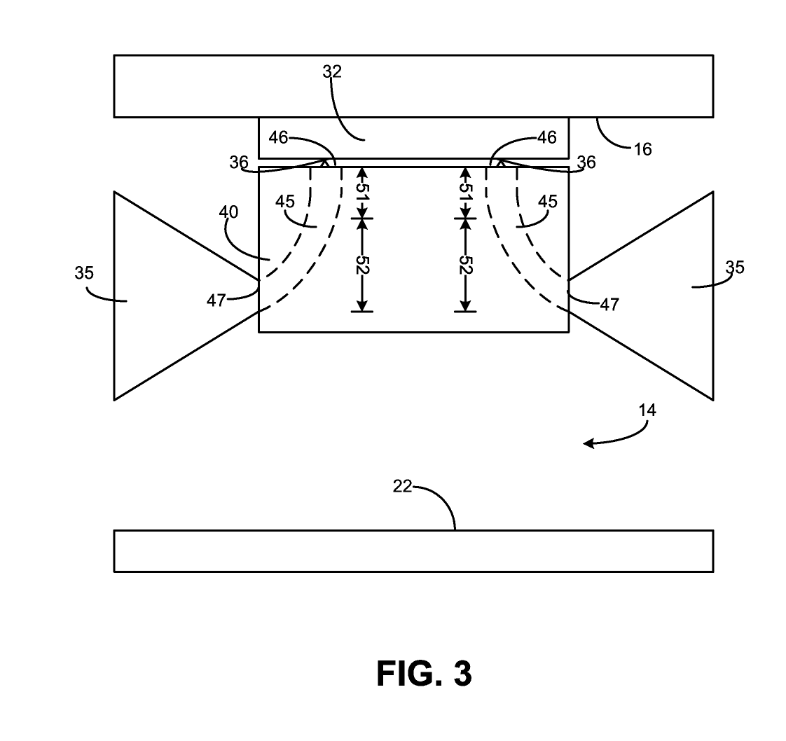

To further illustrate the duct structure 40 and its interaction with one or more fuel jets 35 injected from the one or more orifices 36 of the tip 32 of the fuel injector 30, the duct structure 40, within the combustion chamber 14, is shown in greater detail in FIG. 3. As shown, the plurality of curved ducts 45 are defined within the duct structure 40 as, for example, bores within the duct structure 40. Upon being injected out of the one or more orifices 36, the fuel jets 35 may enter the curved ducts 45 at duct openings 46 and may flow through the curved ducts 45 to duct outlets 47. As shown in the embodiment of FIG. 3, the duct structure 40 may be affixed to the fuel injector 30, or head 18. In such examples, the openings 46 of the plurality of curved ducts 45 may be aligned with the orifices 36, such that the fuel jets 35 enter the curved ducts 45 upon being injected. In some alternative examples, duct structure 40 may be positioned and/or supported within the combustion chamber 14 by support structures, such as any mounting, wiring, or other positioning device suitable for positioning the duct structure 40 within the combustion chamber 14.

The curved ducts 45 may include a first portion 51 and a second portion 52. The first portion 51 may have an alignment that is substantially straight, meaning it may be substantially parallel with the direction of the cylinder in which it is disposed. The first portion 51 may include the opening 46 and, as such, the first portion 51 may be directly aligned with the orifice 36. When the fuel jet 35 is injected, it may directly enter the first portion 51 at the opening 46. Once the fuel jet passes through the first portion 51, it may enter the second portion 52 of the curved duct 45, the second portion being curved with respect to the first portion and allowing the fuel jet 35 to exit the duct structure 40 via the outlet 47. In an example embodiment, the second portion 52 may be curved in the range of 30-150 degrees with respect to the first portion 51, such an angle may be defined as an angle between the opening 46 and the outlet 47. However, other angles of curvature for the second portion 52 are certainly possible.

Use of the duct structure 40, having the plurality of curved ducts 45, may provide improved mixing of a fuel/air mixture within the fuel jets 35 prior to combustion. The duct structure 40 may direct combustion away from the fuel injector 30, such that longer flame lift-off lengths may be achieved. Further, by channeling the fuel jets 35 into the duct structure 40, entrainment of combustion products from downstream regions of the same or neighboring fuel jets 35 may be reduced or inhibited. By using such duct structures 40, levels of soot within the combustion chamber 14 may be reduced greatly.

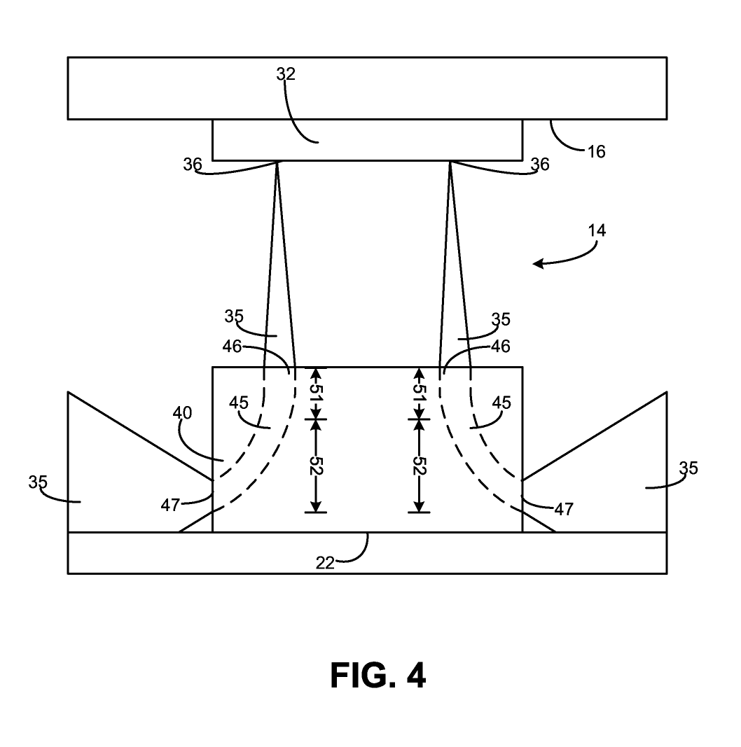

While the example embodiment of FIG. 3 shows the duct structure 40 affixed to the tip 32 or head 18, other arrangements of the elements of FIGS. 1-3 within the combustion chamber 14 are certainly possible. For example, FIG. 4 shows an embodiment of the duct structure 40 within the combustion chamber 14, wherein the duct structure 40 is affixed to the piston 24 via the piston top surface 22. In such examples and as shown, the tip 32 may be configured such that the orifices 36 inject the fuel jets 35 directly downward into the first portions 51 via openings 46.

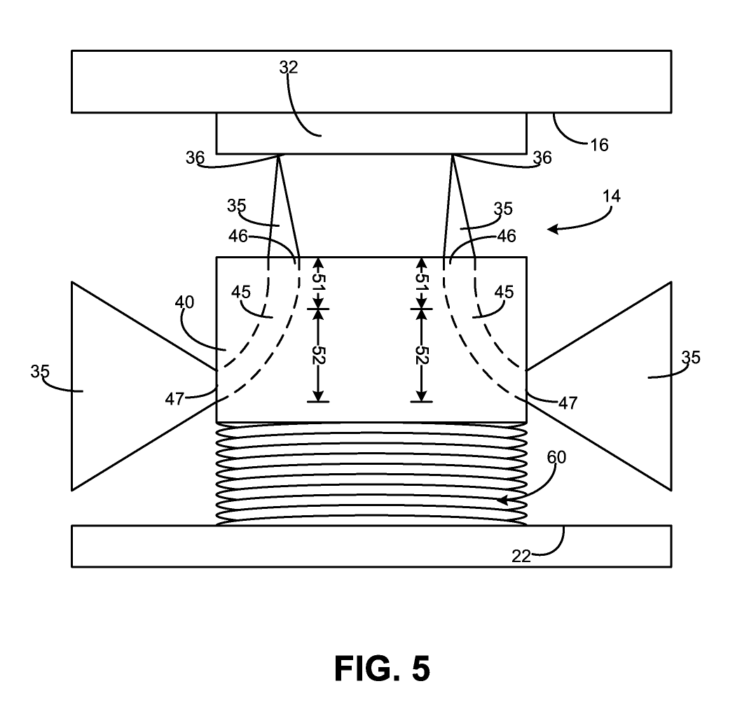

In some such examples, wherein the duct structure 40 is affixed to the piston 24, the duct structure 40 may be affixed to the piston top surface 22 via a spring 60, as shown in FIG. 5. The spring 60 may be configured to allow the duct structure 40 to maintain a substantially constant position for the duct structure 40, relative to the tip 32, within the combustion chamber 14 when the piston 24 is in reciprocating motion. As with the example of FIG. 4, the orifices 36 may be configured to inject the fuel jets 35 directly into the openings 46 of the first portions 51 of the curved ducts 45. By using the spring 60, the duct structure 40 may remain at an expected height, with respect to the piston 24 and/or tip 32, during cycles of the internal combustion engine 10.

### INDUSTRIAL APPLICABILITY

The present disclosure relates generally to internal combustion engines and, more specifically, to ducted combustion systems. While the present disclosure shows the embodiments as related to internal combustion engines having reciprocating pistons, the teachings of the disclosure are certainly applicable to other combustion systems, which utilize diffusion or non-premixed flames, such as gas turbines, industrial burners, and the like. As discussed above, the various arrangements of ducts and their related elements are useful in promoting a substantially uniform fuel/air mixture within fuel jets and may inhibit or reduce entrainment of recirculated combustion products from downstream regions into upstream regions of fuel jets injected into combustion chambers. However, using such systems and methods for ducted combustion may also decrease fuel/air mixing, while reducing equivalence ratio at the lift-off length.

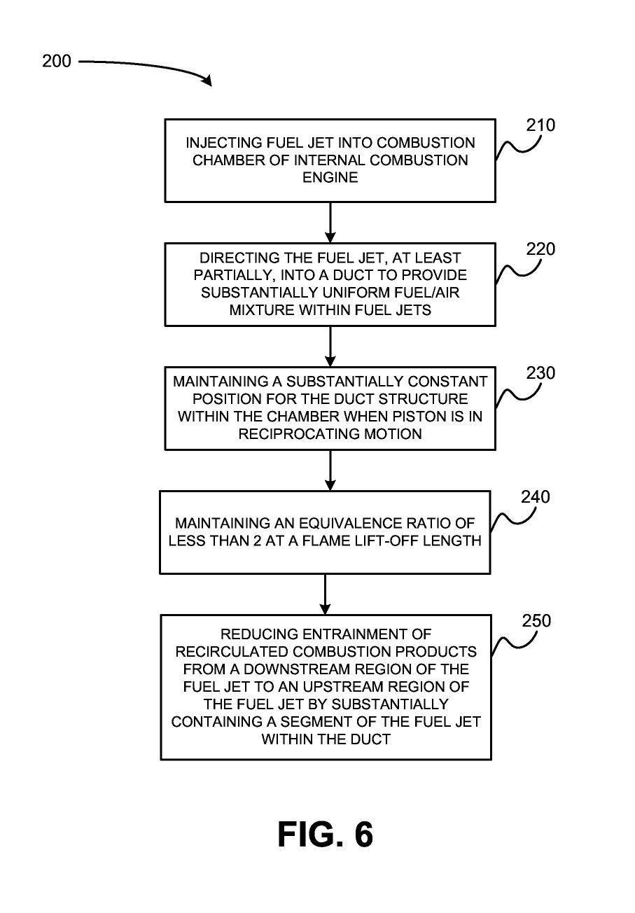

An example method utilizing the ducted combustion systems shown in FIGS. 1-5 and described above is exemplified in the flowchart of FIG. 6, which represents a method 200 for operating a combustion system. The method 200 begins at block 210, by injecting a plurality of fuel jets 35 into the combustion chamber 14 of the internal combustion engine 10. The fuel jets 35 may be directed into the plurality of curved ducts 45 defined by the duct structure 40, to provide a substantially uniform fuel/air mixture within the fuel jets 35, as shown in block 220.

In some examples, the method 200 may include maintaining a substantially constant position for the duct structure 40 within the combustion chamber 14 when the piston 24 is in reciprocating motion, as shown in block 230. In such examples, said positioning may be accomplished by affixing the duct structure 40 to the piston 24 via a spring 60 that is configured to maintain such a constant position for the duct structure 40 within the combustion chamber 14 when the piston 24 is in reciprocating motion.

The disclosed ducted combustion systems may be configured to use duct structure 40 to direct combustion away from the fuel injector tip 32, so that the equivalence ratio at the flame lift-off length, produced during combustion. is reduced. Maintaining a reduced equivalence ratio at the lift-of length may reduce soot formation. Achieving a reduced equivalence ratio at the lift-off length may be accomplished by altering the lift-off length, when employing any of the aspects of the present application. Alterations to the lift-off length may occur if heat is transferred from the fuel/air mixture of the fuel jets 35 to the duct structure 40. Additionally or alternatively, alterations to the lift-off length may be achieved by alteration of fuel jet fluid dynamics, which are resultant of characteristics of the ducts 45. Further, use of ducts 45 may prevent lift-off length recession by acting as a flame arrester.

Substantially soot-free combustion may be achieved if the equivalence ratio at the flame lift-off length is less than two. Therefore, at block 240, the method 200 may include maintaining an equivalence ratio of less than 2 at the flame lift-off length.

At block 250, the method 200 may reduce entrainment of recirculated combustion products from a downstream region of the fuel jet 35 to an upstream region of the fuel jet 35 by substantially containing a segment of the fuel jet 35 within a curved duct 45. Reducing such entrainment may lead to an overall reduction in soot production within the combustion chamber 14 and may lead to greater overall efficiency of the internal combustion engine 10. Presence of ducts 45 may alter amount and position of entrainment of recirculated combustion products, within the fuel jets 35

It will be appreciated that the present disclosure provides ducted combustion systems, internal combustion engines utilizing ducted combustion, and methods for operating combustion systems utilizing ducted combustion. While only certain embodiments have been set forth, alternatives and modifications will be apparent from the above description to those skilled in the art. These and other alternatives are considered equivalents and within the spirit and scope of this disclosure and the appended claims.

What is claimed is:

1. A ducted combustion system, comprising:
a combustion chamber defined as an enclosure bound at a first end by a flame deck surface of a cylinder head of an internal combustion engine, and bound at a second end by a piston top surface of a piston disposed within the internal combustion engine;
a fuel injector in fluid connection with the combustion chamber and including a plurality of orifices in an injector tip of the fuel injector, the plurality of orifices injecting fuel into the combustion chamber as a plurality of fuel jets; and
a duct structure defining a plurality of curved ducts and disposed within the combustion chamber between the flame deck surface and the piston top surface, the plurality of ducts being disposed such that each of the plurality of orifices inject each of the plurality of fuel jets, at least partially, into one of the plurality of curved ducts.

2. The ducted combustion system of claim 1, wherein at least one of the curved ducts includes a first portion and a second portion, the first portion having an opening aligned with one of the plurality of orifices and the second portion curved with respect to the first portion.

3. The ducted combustion system of claim 2, wherein the second portion is angled within the range of 30-150 degrees with respect to the first portion.

4. The ducted combustion system of claim 1, wherein the duct structure is affixed to at least one of the fuel injector and the cylinder head.

5. The ducted combustion system of claim 4, wherein each of the curved ducts includes an opening and each of the openings is positioned in fluid communication with one of the orifices.

6. The ducted combustion system of claim 1, wherein the duct structure is affixed to the piston.

7. The ducted combustion system of claim 6, wherein each of the curved ducts includes an opening and each of the openings is aligned with one of the orifices.

8. The ducted combustion system of claim 6, further comprising a spring, the spring affixing the duct structure to the piston.

9. The ducted combustion system of claim 8, wherein the spring is configured to maintain a substantially constant position for the duct structure within the combustion chamber when the piston is in reciprocating motion.

10. An internal combustion engine, comprising:
an engine block having at least one cylinder bore;
a cylinder head having a flame deck surface disposed at one end of the cylinder bore;
a piston connected to a crankshaft and configured to reciprocate within the cylinder bore, the piston having a piston top surface facing the flame deck surface such that a combustion chamber is defined within the cylinder bore bound at a first end by the flame deck surface and at a second end by the piston top surface;
a fuel injector in fluid connection with the combustion chamber and including a plurality of orifices opening from an injector tip of the fuel injector, the plurality of orifices injecting fuel into the combustion chamber as a plurality of fuel jets; and
a duct structure defining a plurality of curved ducts and disposed within the combustion chamber between the flame deck surface and the piston top surface, the plurality of ducts being disposed such that each of the plurality of orifices inject each of the plurality of fuel jets, at least partially, into one of the plurality of curved ducts.

11. The internal combustion engine of claim 10, wherein at least one of the curved ducts includes a first portion and a second portion, the first portion having an opening aligned with one of the plurality of orifices and the second portion curved with respect to the first portion.

12. The internal combustion engine of claim 11, wherein the second portion is angled within a range of 30-150 degrees with respect to the first portion.

13. The internal combustion engine of claim 10, wherein the duct structure is affixed to at least one of the fuel injector and the cylinder head.

14. The internal combustion engine of claim 10, wherein the duct structure is affixed to the piston.

15. The internal combustion engine of claim 14, further comprising a spring, the spring affixing the duct structure to the piston and configured to maintain a substantially constant position for the duct structure within the combustion chamber when the piston is in reciprocating motion.

16. A method for operating a combustion system, comprising:
injecting a plurality of fuel jets into a combustion chamber of an internal combustion engine, the combustion chamber defined as an enclosure bound at a first end by a flame deck of a cylinder of an internal combustion engine, and bound at a second end by a piston top surface of a piston disposed within the internal combustion engine; and
directing each of the plurality of fuel jets, at least partially, into respective members of a plurality of curved ducts, each of the plurality of curved ducts being defined within a duct structure, to provide a substantially uniform mixture of fuel and air within the combustion chamber.

17. The method of claim 16, further comprising reducing an equivalence ratio at a flame lift-off length.

18. The method of claim 16, wherein directing each of the plurality of fuel jets, at least partially, into respective members of the plurality of curved ducts further includes directing the plurality of fuel jets directly into a first portion of respective members of the plurality of curved ducts, wherein the first portions have a generally straight alignment and flow into a second portion of the respective curved duct that is curved with respect to the first portion.

19. The method of claim 16, wherein injecting the plurality of fuel jets into the combustion chamber of the internal combustion engine includes injecting the plurality of fuel jets, at least partially, into the duct structure, wherein the duct structure is affixed to a fuel injector from which the plurality of fuel jets are injected.

20. The method of claim 16, further comprising maintaining a substantially constant position for the duct structure within the combustion chamber when the piston is in reciprocating motion by affixing the duct structure to the piston via a spring that is configured to maintain the constant position for the duct structure within the combustion chamber when the piston is in reciprocating motion.
